(19) United States
(12) Patent Application Publication
(10) Pub. No.: US 2007/0229585 A1
(43) Pub. Date: Oct. 4, 2007

(54) WASTE INK ABSORBER AND INK JET RECORDING DEVICE INCORPORATING THE SAME

(75) Inventor: Hidehiko Komatsu, Shiojiri-shi (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/695,696

(22) Filed: Apr. 3, 2007

(30) Foreign Application Priority Data
Apr. 3, 2006 (JP) 2006-101698

(51) Int. Cl. B41J 2/165; B01J 20/22

(52) U.S. Cl. 347/31

(57) ABSTRACT

The invention describes a waste ink absorber for an ink jet recording device, wherein the ink is a non-aqueous ink, including a porous plastic prepared by sinter-molding plastic particles; and an oily solvent impregnated into the porous plastic. The invention also describes an ink jet recording device, wherein the ink is a non-aqueous ink, including a waste ink tank including a waste ink diffusing-chamber and an absorber-retaining chamber, and the waste ink absorber, wherein the waste ink absorber is retained in the absorber-retaining chamber and not the waste ink diffusing-chamber.

### BACKGROUND OF THE INVENTION

The entire disclosure of Japanese Patent Application No. 2006-101698, filed Apr. 3, 2006 is expressly incorporated herein by reference.

1. Technical Field

The present invention relates to an ink jet recording device. More specifically, the present invention relates to a waste ink absorber and an ink jet recording device incorporating the waste ink absorber.

2. Related Art

In ink jet recording devices, a flushing operation is used to the prevent discharge ports of the recording head from drying out. This operation includes the idle discharge of ink from the discharge ports. If the discharge ports of the recording head are clogged, then a cleaning operation is performed, wherein the ports are sealed with a cap and the ink is forcibly discharged from the discharge ports using a sucking unit connected to the cap. The ink that is forcibly discharged from the discharge ports is retained in the cap and transported to a waste liquid tank in the ink jet recording device using the sucking unit and the ink is stored as waste liquid. In marginless printing, the ink ejected beyond the edges of the recording medium is also transported to a waste liquid tank by a capturing member disposed on a platen.

In many ink jet recording devices, a waste ink absorber is incorporated in the waste liquid tank. In one example, the waste ink absorber is a non-woven cloth or soft polyurethane foam sheet (JP-A-2002-29066).

In other devices, the capturing member has a similar function to that of the absorber, and is comprised of a soft polyurethane foam sheets (e.g., JP-A-2000-118058, JP-A-2003-191545, JP-A-2004-17497, JP-A-2004-250247, JP-A-2004-17497, and JP-2005-197980).

As previously described, a non-woven cloth is used as the material for the waste ink absorber. Examples of the non-woven cloth include regenerated non-woven cloth of cellulose fibers (in particular, rayon fibers) and non-woven cloth of polyacrylic fibers having excellent water absorbing property. Polyacrylic fibers are preferred since they impart higher flame retardancy and facilitate cutting. Alternatively, a non-woven cloth containing both regenerated cellulose fibers and polyacrylic fibers is sometimes used.

However, urethane foams that have been widely employed in the waste ink absorbers and capturing members in the related art deteriorate easily due to the solvent in the ink.

Another difficulty that developers have faced is that the coloring agent component of the waste ink is not easily absorbable compared to the solvent component and water component of the ink. In particular, when a pigment-based ink containing a pigment as the coloring agent component is used, only the solvent component of the ink penetrates into the absorber, leaving the pigment particles and solid components to accumulate on the surface of the absorber. When the solid components and pigment particles remain on the surface of the absorber, neither flushing nor cleaning can be properly performed, although the absorber still has sufficient absorbing capacity. Moreover, when the waste ink discharged into the waste ink-diffusing chamber is foamy, it is difficult for the absorber to absorb.

Thus, there is a need for a waste ink absorber that is resistant to solvents that has improved absorbing properties and resists ink foaming.

### BRIEF SUMMARY OF THE INVENTION

The present invention overcomes these and other challenges by providing a waste ink absorber that has solvent resistance, which suppresses drying of the solvent component of the ink, inhibits foaming of the ink, and allows pigment particles to penetrate into the absorber.

According to one aspect of the present invention, a waste ink absorber for an ink jet recording device for a non-aqueous ink includes a porous plastic prepared by sinter-molding plastic particles and an oily solvent impregnated into the porous plastic.

Another aspect of the invention is an ink jet recording device incorporates the waste-ink absorber described above.

Yet another aspect of the invention is an ink jet recording device including a waste ink tank including a waste ink diffusing-chamber and an absorber-retaining chamber, and the waste ink absorber described above, wherein the waste ink absorber is retained in the absorber-retaining chamber and not the waste ink diffusing-chamber.

The waste ink absorber of the invention has solvent resistance and the ability to suppress foaming irrespective of types of ink. The waste ink absorber also has excellent ink-absorbing and retaining properties. Thus, the absorbing capacity of the waste ink absorber can be fully utilized, and flushing and cleaning can be performed for a long period of time.

### BRIEF DESCRIPTION OF THE DRAWINGS

The invention will be described with reference to the accompanying drawings, wherein like numbers reference like elements.

FIG. 1 is an oblique perspective view showing a waste ink tank having a waste ink-diffusing chamber and an absorber-retaining chamber, from which the absorber has been removed.

FIG. 2 is an oblique perspective view showing the waste ink tank with the absorber within the absorber-retaining chamber.

FIG. 3 is an oblique perspective view showing another example of the waste liquid tank.

FIG. 4 is an oblique perspective view showing a waste ink tank having a waste ink-diffusing chamber.

FIG. 5 is a cross-sectional view of the waste ink tank shown in FIG. 4.

FIG. 6 is a partial oblique perspective view of an ink jet recording device incorporating a waste ink tank for retaining waste ink.

### DETAILED DESCRIPTION OF THE INVENTION

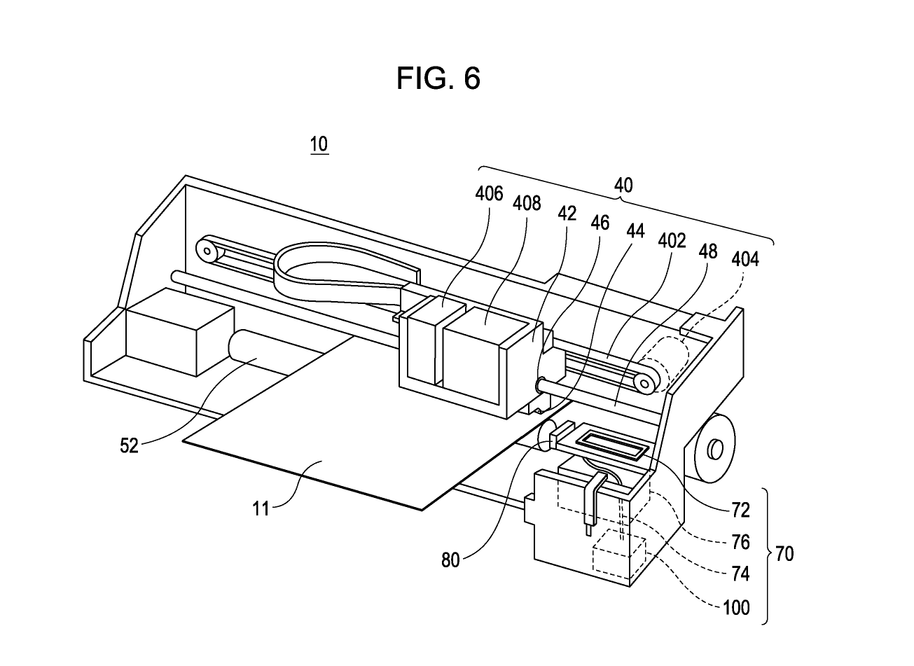

An example of the ink jet recording device equipped with a waste ink tank that retains waste ink resulted from flushing and cleaning is shown in FIG. 6. FIG. 6 is a partial oblique perspective view of an ink jet recording device 10 which shows the partial structure of a printing unit 40 and a waste ink-transporting unit 70. The printing unit 40 includes a carriage 42 on which ink cartridges are placed, a recording head 44 that ejects ink, a shaft hole 46 formed in the carriage 42, and a guiding shaft 48 that penetrates the shaft hole 46 and supports the carriage 42 such that the carriage 42 is capable of sliding in a direction substantially perpendicular to the feeding direction. The recording head 44 includes a plurality of ink discharge ports aligned in the direction of feeding a recording medium 11. The printing unit 40 further includes a timing belt 402, a carriage motor 404, a black ink cartridge 406, and a color ink cartridge 408.

As the carriage motor 404 drives the timing belt 402, the carriage 42 is guided by the guiding shaft 48 and reciprocates in a direction substantially perpendicular to the feeding direction of the recording medium 11. The recording head 44 having black ink discharge ports and color ink discharge ports is mounted on the carriage 42 at the side opposite to the recording medium. The black ink cartridge 406 and the color ink cartridge 408 that supply ink to the recording head 44 are detachably attached on the upper side of the carriage 42.

The ink jet recording device 10 further includes a waste ink-transporting unit 70 that transports the waste ink ejected from the recording head 44 and a wiping member 80. The waste ink-transporting unit 70 has a cap 72 that seals the discharge ports of the recording head 44. An exemplary sucking unit of the waste ink-transporting unit 70 includes a connecting tube 74 that connects the discharge ports of the recording head 44 to the cap 72 and a pump 76 that transports the ink in the connecting tube 74 by elastically deforming a part of the connecting tube 74. The waste ink-transporting unit 70 further includes a waste liquid tank 100 that stores the ink which has been transported by the pump 76. The cap 72 of the waste ink-transporting unit 70 is located in a non-recording region (home position) outside the recording region (path in which the recording medium 11 is fed). The recording medium 11 is fed by a transfer roller (not shown) or a discharge roller 52. The wiping member 80 is elastic and located near the recording-region-side-end of the cap 72.

When the ink jet recording device 10 having the above-described structure is not performing a recording operation, the carriage 42 moves to the non-recording region (home position). When the recording head 44 moves to a position directly above the home position, the cap 72 can be lifted upward toward the carriage 42 to cap the surface of the recording head 44 having the discharge ports.

Since the surface of the recording head 44 having the discharge ports is capped with the cap 72, drying of the discharge ports of the recording head 44 can be suppressed. Furthermore, a flushing operation wherein ink droplets are discharged from the recording head 44 and held in the cap 72. Typically, this flushing operation is conducted by a driving signal that is separate from to recording driving signals.

When the cap 72 is capping the recording head 44, the air inside the recording head 44 and the cap 72 is sucked by the pump 76 such that the ink is forcibly sucked and ejected from the discharge ports of the recording head 44. Since the ink is forcibly sucked and discharged from the discharge ports of the recording head 44, the recording head 44 is cleaned and the problem of clogged discharge ports is solved.

When the carriage 42 returns to the recording region from the non-recording region, the carriage 42 first detaches from the cap 72. Then as the carriage 42 moves toward the recording region, the wiping member 80 advances along the recording head 44 path so that the wiping member 80 wipes away the ink on the nozzle surface of the recording head 44.

During cleaning, flushing, and other associated operations, the ink retained in the cap 72 is sucked by the pump 76 of the waste ink-transporting unit 70 and transported to the waste liquid tank 100 through the connecting tube 74 that connects the cap 72 to the waste liquid tank 100.

The waste liquid tank is preferably hermetically closed at the portion connected to the connecting tube 74. If the portion connected to the tube 74 is open, then the ink in that portion is dried and solidified, inhibiting the waste ink absorber from absorbing the ink.

In order to decrease the amount of dried ink and increase the amount of waste ink retained in the tank, a portion of the waste liquid tank may be open. By opening a portion of the ink tank, however, the ink may be scattered due to the vibration of the ink jet recording device during the recording process, or may flow out as the ink jet recording device 10 is tilted. To overcome this problem, an absorber for absorbing the waste ink is usually incorporated in the waste liquid tank 100.

The waste ink absorber according to the invention is composed of a porous plastic made by sinter-molding plastic particles. Thermoplastic particles may be used as the plastic particles. Examples thereof include particles of polyolefin resins (e.g., polyethylenes such as ultragiant molecular weight polyethylene and high-density polyethylene, and polypropylene), vinyl resins (e.g., polyvinyl chloride resin), polyester resins (e.g., polyarylate), polyamide resins, polystyrene resins, acrylic resins, polysulfone resins, polyether sulfone resins, polyethylene sulfide resins, fluorocarbon resins, and cross-linked polyolefin resins, and mixtures or combinations of the above.

Examples of the fluorocarbon resins include polytetrafluoroethylene, polyfluoroacryl acrylate, polyvinilidene fluoride, polyvinyl fluoride, and hexafluoropropylene.

Examples of the cross-linked polyolefin resin materials include polyolefin resins, e.g., polypropylenes such as low-density polyethylene, intermediate-density polyethylene, and high-density polyethylene and polyethylenes, crosslinked by ionizing radiation such as γ or X radiation or chemically with a cross-linking agent such as an inorganic compound, e.g., aluminum chloride or nitrogen fluoride, or an organic peroxide such as tert-butyl-cumyl-peroxide, dicumyl-peroxide, 2,5-dimethyl-2,5-di(tert-butylperoxy)hexane, or acetylene peroxide.

The average particle diameter of the plastic particles is not particularly limited but is preferably 1,000 μm or less. The melt flow rate (MFR) of the particles is also not particularly limited, but plastic particles having a MFR of 0.01 or less are preferred since they result in sintered porous plastic with uniform pore diameters.

The porous plastic used in this embodiment can be manufactured by sinter-molding thermoplastic particles by static molding or dynamic molding.

Static molding is also known as in-mold sintering. During this process, thermoplastic particles may be filled in a cavity formed in the gap between the molding dies and then heated together with the molding dies.

Examples of the dynamic molding include: (1) a ram extrusion process conducted with a ram extruder having a molding die at the front end portion and equipped with a piston (plunger) which reciprocates inside a cylinder, which may be performed at a controllable temperature; (2) an injection molding process conducted with an injection molding machine having a molding die at the front end portion and equipped with a screw in a cylinder, which may be performed at a controllable temperature; (3) an extrusion molding process conducted with an extrusion molding machine having a molding die at the front end portion and equipped with a screw in a cylinder, which may be performed at a controllable temperature (4) a compression molding process conducted with a compression molding machine, using a female die and a male die inserted to the interior of the female die, wherein the material is filled in the cavity formed inside the female die and then the molding dies are heated; and (5) a continuous pressing process using a continuous pressing machine having a molding die constituted from a pair of moving belts at the upper and lower sides at the front end portion or from a moving belt at the lower side, in which the raw material is extruded into the molding die using a cylinder, which may be performed at a controllable temperature.

Any process adequate for the required shapes, physical properties, and the like of the porous plastic used in this embodiment may be selected from among these static and dynamic molding processes.

The resulting molded product (molded board) of the sintered porous plastic appears as a typical plastic molded product (molded board) but has a myriad of pores connected to each other in various directions. The molded product of the sintered porous plastic described above is available commercially. In addition, various molded products (molded boards) having various pore diameters can be easily acquired (e.g., Porex Porous Plastic produced by Porex Technologies and Fildus produced by Mitsubishi Plastics, Inc).

The waste ink absorber of this embodiment may be imparted with antistatic properties by various methods. adding 1 to 5 percent by weight (preferably 1 to 2 percent by weight) of a conducting agent, such as carbon black, carbon fibers, metal powder, or metal-coated potassium titanate, to the thermoplastic particles and then sinter-molding the resulting mixture.

The waste ink absorber of this invention may be impregnated by an oily solvent. The oily solvent may be one having a melting point of 10° C. or less and a boiling point of 150° C. or more and a mixture of two.

The oily solvent having a melting point of 10° C. or less and a boiling point of 150° C. or more used to impregnate the waste ink absorber preferably has resistance to evaporation. Examples oily solvents with such properties include hydrocarbons such as nonane (melting point: −53° C., boiling point: 150° C.), decane (melting point: −30° C., boiling point: 174° C.), dodecane (melting point: −10° C., boiling point: 216° C.), decalin (melting point: −42° C., boiling point: 195° C.) pentylbenzene (melting point: −75° C., boiling point: 205° C.) α-pinene (melting point: −64° C., boiling point: 156° C.), kerosene (melting point: 0° C. or less, boiling point: 180-330° C.), diesel oil (melting point: 0° C. or less, boiling point: 170-340° C.), spindle oil, machine oil, Isopar G (trade name, produced by ExxonMobil Chemical) (melting point: −57° C., boiling point: 163° C. to 176° C.), Isopar H (melting point: −63° C., boiling point: 179° C. to 187° C.), Isopar L (melting point: −57° C., boiling point: 189° C. to 209° C.) (trade name, produced by ExxonMobil Chemical), mesitylene (melting point: −44° C., boiling point: 164° C.), tetralin (melting point: −35° C., boiling point: 207° C.), and cumene (melting point: −96° C., boiling point: 152° C.); mono- and polyols such as 3,5,5-trimethyl-1-hexanol (melting point: −70° C. or less, boiling point: 194° C.), 1-decanol (melting point: 6° C., boiling point: 232° C.), 1,3-propanediol (melting point: −32° C., boiling point: 214° C.), 1,3-butanediol (melting point: −50° C. or less, melting point: 208° C.), 1,5-pentanediol (melting point: −16° C., boiling point: 242° C.), hexylene glycol (melting point: −50° C. or less, boiling point: 197° C.), and octylene glycol (melting point: −40° C., boiling point: 243° C.); cyclohexanone (melting point: −45° C., boiling point: 156° C.), benzyl acetate (melting point: −52° C., boiling point: 214° C.), 2-(benzyloxy)ethanol (melting point: −25° C. or less, boiling point: 256° C.), dipropylene glycol monomethyl ether (melting point: −80° C., boiling point: 190° C.), thiodiethanol (melting point: −10° C., boiling point: 282° C.), and diethylene glycol diethyl ether (melting point: −44° C., boiling point: 189° C.).

When the melting point is 10° C. or less, the compound will be in a liquid state during the operation of jet recording device and the ink can be rapidly absorbed by the absorber. When the melting point is higher than 10° C., the solvent is in a solid state during the operation of the device, solidified absorbed material will form in the gaps in the in absorber, inhibiting the rapid absorption of the ink. When the boiling point is 150° C. or more, the solvent is not readily vaporizable and thus can maintain its effects for a long period of time.

When a waste ink absorber composed of polyurethane foam is impregnated with diethylene glycol diethyl ether, the polyurethane foam may swell and undergo a chemical reaction, resulting in a significant decrease in ink-absorbing property. Advantageously, this problem does not occur with porous plastic. Thus, diethylene glycol diethyl ether can be used in this embodiment. Examples of other preferable diethylene glycol compounds include diethylene glycol; diethylene glycol ether (in particular, alkyl ether), e.g., diethylene glycol monomethyl ether, diethylene glycol dimethyl ether, diethylene glycol methyl ethyl ether, diethylene glycol monoethyl ether, diethylene glycol mono-n-butyl ether, and diethylene glycol di-n-butyl ether; and diethylene glycol ester e.g., diethylene glycol monoethyl ether acetate, diethylene glycol mono-n-butyl ether acetate, and diethylene glycol monoacetate.

The porous plastic may be impregnated with one of or a mixture of two or more of the oily solvents described above.

The specific composition of the ink used in association with the invention is not particularly limited and any ink composition that has been used in ink jet recording can be used. However, the waste ink absorber of this embodiment is particularly suited for non-aqueous ink compositions (oily ink compositions). Non-aqueous ink compositions for ink jet recording are mainly composed of a pigment, a dispersant, and an organic solvent.

Various organic and inorganic pigments usable in general non-aqueous ink compositions for ink jet recording can be used as the pigment. Pigments having solvent resistance are particularly preferred. Examples of the pigments useful as this type of pigment include C. I. Pigment Yellow 16, 17, 83, 93, 94, 95, 97, 98, 108, 109, 110, 113, 117, 120, 128, 129, 133, 138, 139, 151, 153, 154, 155, 168, 169, 173, 180, 185, and 193, C. I. Pigment Orange 16, 18, 19, 31, 34, 36, 42, 43, 51, 61, 63, and 71, C. I. Pigment Red 48:1, 48:2, 48:3, 48:4, 52:1, 52:2, 57:1, 63:1, 63:2, 65, 66, 67, 68, 83, 88, 115, 122, 123, 133, 144, 146, 149, 150, 151, 166, 170, 171, 175, 176, 177, 178, 179, 185, 187, 189, 190, 194, 202, 208, 209, 214, 216, 220, 221, 224, 242, 243, 243:1, 246, and 247, C. I. Pigment Blue 15:1, 15:2, 15:3, 15:4, 16, and 60, C. I. Pigment Violet 5:1, 19, 23, 31, and 32, C. I. Pigment Green 7, 10, 12, and 36, C. I. Pigment Brown 23, 25, and 32, C. I. Pigment black 1, and 7, and C. I. Pigment White 1, 5, and 6.

The non-aqueous ink composition may contain any of various organic solvents usable for general non-aqueous ink compositions for ink jet recording. Examples thereof include saturated hydrocarbon solvents.

Examples of the saturated hydrocarbon solvents include commercially available saturated hydrocarbon solvents mainly used in the existing non-aqueous ink compositions (oily ink composition in particular) for ink jet recording, such as isoparaffinic mixtures, e.g., Isopar E, Isopar G, Isopar H, Isopar L, and Isopar M (all produced by ExxonMobil Chemical), Shellsol (produced by Shell Oil Co.), Soltrol (produced by Phillips Oil Co.), Begasol (produced by Mobil Petroleum Co., Inc.), and IP Solvent 2835 (produced by Idemitsu Kosan Co., Ltd.); and cycloparaffin mixtures, e.g., Exxsol D130 (produced by ExxonMobil Chemical). Other examples of commercially available saturated hydrocarbon solvents include liquid paraffins (called “light liquid paraffins” in the Japanese Pharmacopoeia), which are mixtures of three main components, normal paraffin, isoparaffin, and monocyclic cycloparaffin, such as Moresco White P-40 and Moresco White P-55 (both produced by Matsumura Oil Research Co.) and Liquid Paraffin No. 40-S and Liquid Paraffin No. 55-S produced by Chuokasei Co., Ltd.

Normal paraffin hydrocarbons such as octane, nonane, decane, and dodecane, isoparaffin hydrocarbons such as isooctane, isodecane, and isododecane, and cycloparaffin hydrocarbons such as cyclohexane, cyclooctane, cyclodecane, and decalin may also be used.

A saturated hydrocarbon solvent having a viscosity of 20 mPa·s or less at 25° C. is preferable for stability in the ink discharge. A low-viscosity saturated hydrocarbon solvent and a high-viscosity saturated hydrocarbon solvent may be mixed to adjust the viscosity. Furthermore, in order to balance the need for increased printing rates by accelerating the evaporation and drying and the need to prevent clogged nozzles, the boiling point of the saturated hydrocarbon solvent is preferably in the range of 180 to 360° C./mmHg.

The non-aqueous ink composition may also contain another organic solvent miscible with the saturated hydrocarbon solvent if necessary, in order to adjust the drying property, melting point, and viscosity of the ink, so long as the surface tension is not decreased. Examples of such an organic solvent include lower alcohols such as methanol, ethanol, and propanol, and alkyl ethers of (poly)alkylene glycols such as (poly)ethylene glycol and (poly)propylene glycol.

The dispersant may contain any of various dispersants that are generally used in the non-aqueous ink compositions for ink jet recording. For example, various pigment dispersants and polymeric pigment dispersing-resins soluble in organic solvents may be used.

Examples of the preferable pigment dispersants include reaction products between amine compounds and self-condensation products of 1,2-hydroxystearic acid. In particular, a reaction product between polyallylamine and a self-condensation product of 1,2-hydroxystearic acid, e.g., commercially available Solsperse 17000 and 18000 produced by Avecia KK, may be used.

Other examples of the pigment dispersant include long-chain alkylamine acetate compounds such as octadodecylamine acetate, quaternary ammonium salts such as alkyltrimethylammonium chloride, polyoxyethylene derivatives such as polyoxyethylene monostearate, sorbitan acid esters of long-chain fatty acids such as sorbitan monooleate, sorbitan monolaurylate, and sorbitan monostearate, and commercially available products such as Solsperse 5000 (produced by Avecia KK), a polyamine compound, EFKA47 (produced by EFKA Chemicals), and a polyester polymeric compound, Hinoact KF1-M and T-7000 (produced by Takefu Fine Chemicals).

Examples of the pigment-dispersing resin include petroleum resins, rosin-modified maleic acid resins, rosin-modified phenolic resins, alkylphenol resins, alkyd resins, aminoalkyd resins, acrylic resins, polyamide resins, and coumarone-indene resins. The amount of dispersant is 0.1 to 10 times the amount of the pigment on a weight basis.

In order to improve the ink's ability to stick to the print medium, various binder resins used in general non-aqueous ink compositions for ink jet printing may be used. Various additives such as a surfactant, a viscosity modifier, an antifoaming agent, a film-forming aid, and the like may also be added.

The viscosity of the nonaqueous ink composition is typically 1.0 to 30.0 mPa·s and preferably 3.0 to 10.0 mPa·s at ambient temperature during the use. At a viscosity within this range, various properties including ejection stability at high speed printing can be satisfactorily controlled. Moreover, the surface tension of the non-aqueous ink composition is 20 to 35 mN/m at 25° C., for example.

The waste ink tank with the waste ink absorber used in the invention is not particularly limited if it is an ink tank that stores the waste ink resulting from flushing and cleaning for the ink jet recording device. A waste ink tank used to store the waste ink discharged during marginless printing is an example of a waste ink tank that may be used in association with the present invention.

The waste ink tank may be closed or open. Preferably, at least the portion where the waste ink flows into the interior of the tank is closed. The interior of the ink tank may be substantially filled with the waste ink absorber.

The waste ink tank preferably includes a waste ink diffusing chamber and an absorber-retaining chamber. Here, the waste ink-diffusing chamber does not include the waste ink absorber. The waste liquid tube that guides the waste ink to the waste ink tank is inserted into the waste ink diffusing chamber. The absorber-retaining chamber is a space filled with the waste ink absorber.

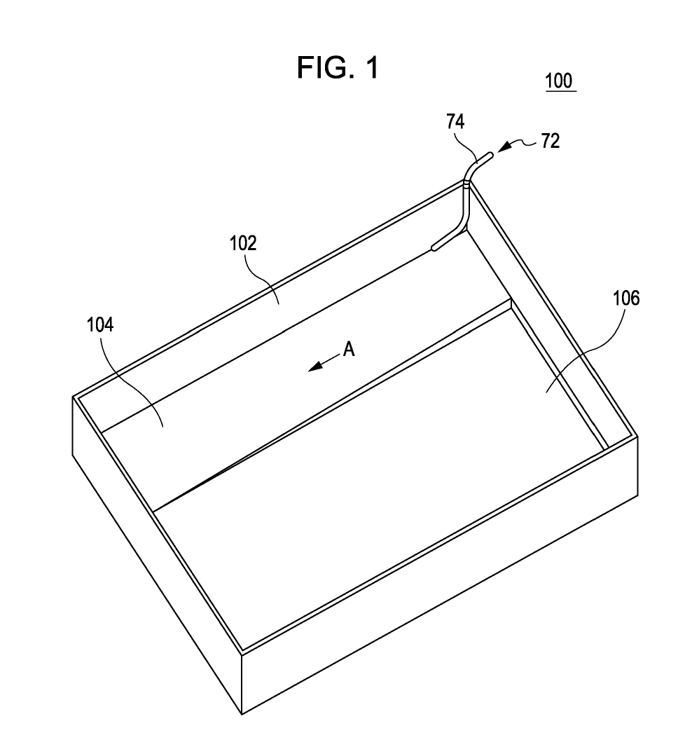

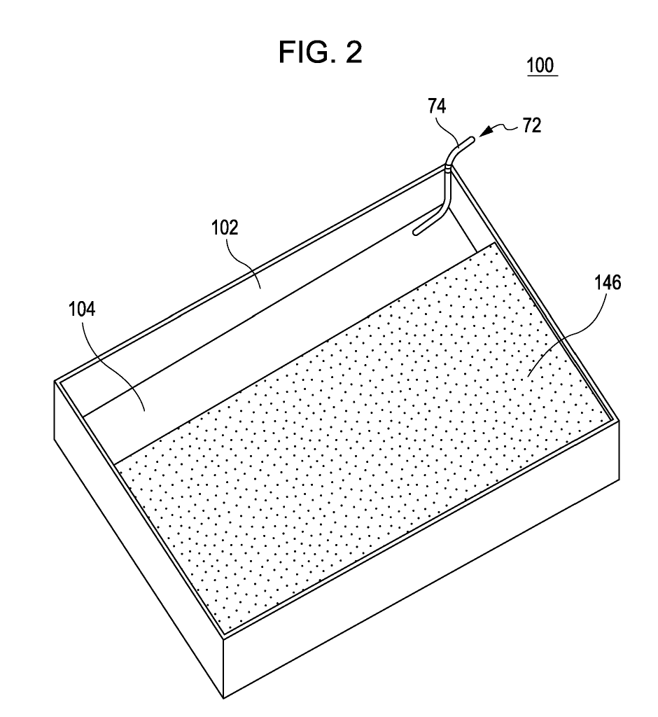

FIG. 1 is an oblique perspective view showing a waste liquid (ink) tank 100 having a waste ink-diffusing chamber and an absorber-retaining chamber, from which the absorber has been removed. FIG. 2 is an oblique perspective view showing the waste ink tank 100 with an absorber 146 filling the absorber-retaining chamber.

The waste ink tank 100 includes a main body 102 which is substantially rectangular parallelepiped with the entire top face being open. The waste ink tank 100 has a waste ink-diffusing chamber 104 having a sloped bottom for allowing the waste ink to flow down along with an absorber-retaining chamber 106 disposed next to the waste ink-diffusing chamber 104. The absorber-retaining chamber 106 accommodates the waste ink absorber 146. The waste ink-diffusing chamber 104 has its top open and the bottom is sloped to allow the waste ink to flow in the direction of the arrow A. The bottom of the absorber-retaining chamber 106 is lower than the bottom of the waste ink-diffusing chamber 104 while the top is open, thereby rendering a tray-shaped absorber-retaining chamber 106. The waste ink is transported to the waste ink tank 100 from the cap 72 via the connecting tube 74. The waste ink flowing into the waste ink-diffusing chamber 104 flows down along the sloped bottom of the waste ink-diffusing chamber 104 in the direction of arrow A. Alternatively, the bottom of the waste ink-diffusing chamber 104 may be level or sloped toward the absorber-retaining chamber 106.

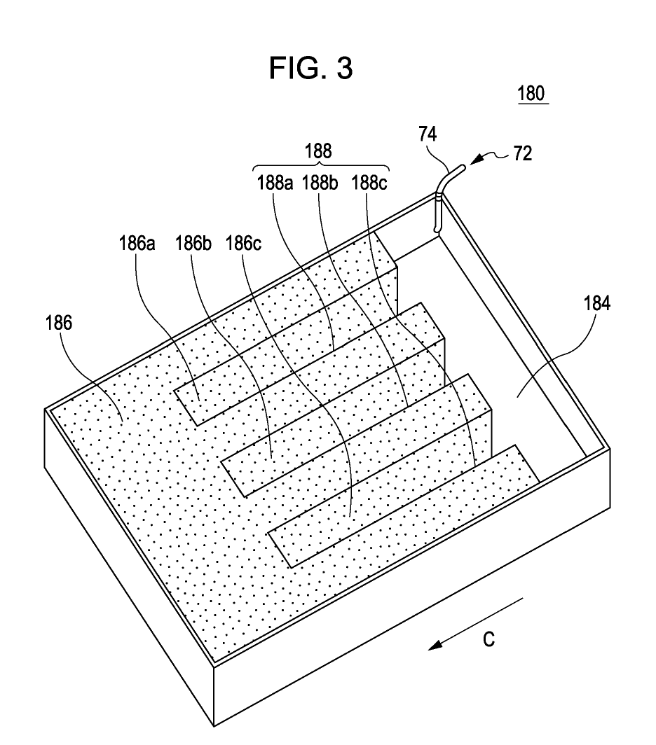

FIG. 3 is an oblique perspective view showing another example of the waste liquid tank. The waste liquid tank 180 shown in FIG. 3 is substantially rectangular parallelepiped with an open top. The waste liquid tank 180 has a waste ink-diffusing chamber 184 and an absorber-retaining chamber next to the waste ink-diffusing chamber 184. An absorber 186 is placed in the absorber-retaining chamber. The waste ink-diffusing chamber 184 has its top open. The waste liquid tank 180 has waste ink secondary paths 188, e.g., 188a, 188b, and 188c, that guide the ink in a direction (the direction indicated by arrow C in FIG. 3). The waste ink secondary paths 188a, 188b, and 188c have their tops open and their bottoms may be sloped downward from the waste ink-diffusing chamber 184 or may be leveled.

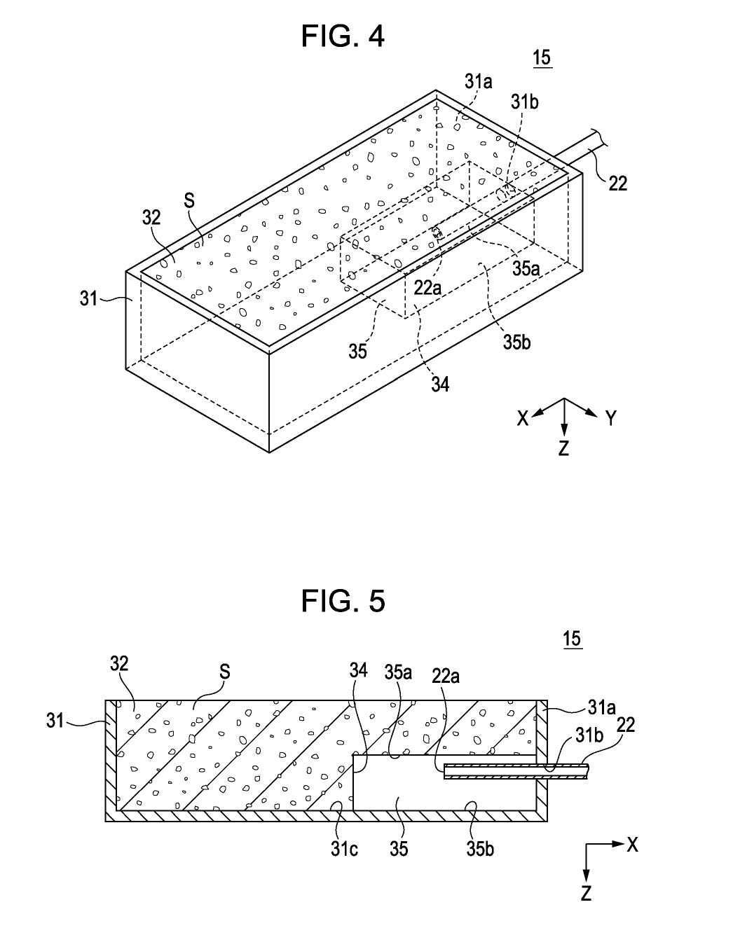

The waste ink-diffusing chamber may take a form of a chamber whose bottom surface includes a waste ink tank, whose top surface and four side surfaces are formed by a waste ink absorber. A waste ink tank including a waste ink-diffusing chamber of this form is shown in FIG. 4 (oblique perspective view) and FIG. 5 (cross-sectional view).

As shown in FIGS. 4 and 5, a waste liquid tank 15 includes a collecting container 31 and a waste ink absorber 32. The collecting container 31 is a box with its top open. A collecting space S substantially is of the shape of a rectangular parallelepiped and is located inside the collecting container 31. An insertion hole 31b is formed in a right side surface 31a of the collecting container 31. The insertion hole 31b is a circular hole opening which extends in the direction X from the outer surface of the collecting container 31 into the collecting space S. The insertion hole 31b is formed substantially at the center of the right side surface 31a, and the hole diameter is nearly the same as the outer diameter of a discharge tube 22.

As shown in FIG. 4, the discharge tube 22 is inserted to the insertion hole 31b. At the front end of the discharge tube 22, there is a circular discharge opening 22a for discharging the waste ink. Because the discharge opening 22a is located inside the collecting space S, the waste ink can be discharged from the discharge tube 22 to the collecting space S (inside the waste liquid tank) through the discharge opening 22a.

As shown in FIG. 4, the collecting space S contains the waste ink absorber 32. The waste ink absorber 32 is composed of a porous material having many pores and has a shape of a rectangular parallelepiped substantially the same as the shape of the collecting space S. The waste ink absorber 32 can absorb the waste ink and retain the ink in the pores by capillarity action or the like. The waste ink absorber 32 also allows the absorbed ink to be evaporated through the open top of the collecting container 31 at a predetermined evaporation ratio. In other words, the waste ink absorber 32 allows the absorbed waste ink to be evaporated at a rate selected to decrease the volume of the ink and retain the ink inside the pores.

The maximum volume (saturation amount) of the ink that can be retained in the waste ink absorber 32 depends on the total volume of the pores. For example, the total volume of the pores can be adjusted to 50 times the unit discharge volume, or the amount of waste ink generated by 50 cleaning operations. Moreover, the evaporation rate can be adjusted to 50% so that the waste ink absorber 32 can retain the ink while reducing the volume of the absorbed ink by half. In such a case, when cleaning operation is conducted 100 times, the waste ink absorber 32 allows 50% of the total amount of waste ink to evaporate, retaining waste ink equaling the amount of 50 cleaning operations in the pores. In other words, the saturation amount of ink that can be retained in the waste liquid tank can be increased to 100 the amount of ink discharged in 100 cleaning operations.

As shown in FIGS. 4 and 5, a recess 34 extending from the right side surface of the waste ink absorber 32 is formed at a position opposite to the insertion hole 31b. The recess 34 is formed by cutting out the lower central portion of the right side surface 31a of the waste ink absorber 32. By forming the recess 34, a space covered with the waste ink absorber 32 (recess 34) and including the discharge opening 22a is formed. Thus, waste ink is discharged from the discharge tube 22 into a closed space. The waste ink introduced in this space is rapidly absorbed into the waste ink absorber 32 without being evaporated and dried.

As shown in FIGS. 4 and 5, the waste ink-diffusing chamber 35 is a space having a shape of a rectangular parallelepiped defined by the inner walls of the collecting container 31 and the recess 34. As shown in FIG. 5, a top surface 35a and a bottom surface 35b of the waste ink-diffusing chamber 35 are respectively defined by the upper surface of the recess 34 and a bottom surface 31c of the collecting container 31. The volume of the waste ink-diffusing chamber 35 can be adjusted to the dimensions that can store the waste ink generated by five times of continuous cleaning operations, or the amount of five times the unit discharge amount.

As shown in FIG. 5, the discharge opening 22a is located between the top surface 35a and the bottom surface 35b of the waste ink-diffusing chamber 35. As shown in FIGS. 4 and 5, the discharge opening 22a is preferably located at the center of the waste ink-diffusing chamber 35 in the horizontal direction and at the center in the axial direction of the tube.

When the waste ink is discharged from the discharge opening 22a, the waste ink falls down by its own weight and reaches the bottom surface 35b. The discharged ink on the bottom surface 35b is then isotropically diffused toward outside from the center along the bottom surface 35b due to an adhesion force and the like. Most of the discharged ink diffused along the bottom surface 35b is eventually diffused outside the waste ink-diffusing chamber 35 (the absorber-retaining-chamber-side) along the bottom surface 31c of the collecting container 31 without drying or solidifying. The discharged ink is then absorbed and retained in the absorber-retaining chamber by the capillarity action of the waste ink absorber 32 or the like.

The waste ink absorber can be used for waste ink disposal of any ink compositions used in the ink jet recording, in particular, the waste ink absorber may be used in the waste ink disposal of non-aqueous ink compositions.

### EXAMPLES

The invention will now be described by way of examples which do not limit the scope of the invention.

### I. Preparation of Waste Ink Absorber

### Example 1

### Porous Material A

A ultragiant molecular weight-polyethylene having an average particle diameter of 160 μm and a melt flow rate (MFR) of 0.01 or less was filled in a gap portion of molding dies having rectangular cross-sections such that the layer thickness ratio is 70% of the total final thickness of the end product filter. The ultragiant molecular weight-polyethylene was then heated at 160° C. to 220° C. for 30 minutes to obtain a porous material (thickness: 20 mm) with a large pore diameter.

The porous material was homogeneously impregnated with an oily solvent, 3,5,5-trimethyl-1-hexanol (melting point: 70° C. or less, boiling point: 194° C.), such that the coating amount was 200 g/m² to prepare a waste ink absorber A of Example 1.

### Example 2

### Porous material B

A porous material having a pore diameter smaller than that of the porous material A of Example 1 above was obtained by the same method as in Example 1 except that an ultragiant molecular weight-polyethylene having an average particle diameter of 50 μm was used.

The porous material was homogeneously impregnated with an oily solvent, diethylene glycol diethyl ether (melting point: −44° C., boiling point 189° C.) such that the coating amount was 200 g/m² to obtain a waste ink absorber B of Example 2.

### Example 3

### Waste Ink Absorber C for Comparison

A soft polyurethane foam sheet having a thickness of 20 mm was used as the waste ink absorber for comparison. The sheet was homogeneously impregnated with diethylene glycol diethyl ether (melting point: −44° C., boiling point; 189° C.) such that the coating amount was 200 g/m².

### Example 4

### Waste Ink Absorber D for Comparison

A soft polyurethane foam sheet having a thickness of 20 mm was directly used without impregnation with a solvent.

### II. Preparation of Ink Set

### 1. Preparation of Black Ink Composition

Solsperse 17000 (3 parts) was dissolved in Liquid Paraffin No. 40-S (12 parts). To the resulting solution, 5 parts of Carbon Black MA-7 (Produced by Mitsubishi Chemical Corporation) were added as a pigment, and the resulting mixture was stirred and dispersed with an Eiger mill to obtain a black pigment dispersion.

The black pigment dispersion (15 parts) was mixed with Liquid Paraffin No. 40-S (40 parts) and Isopar M (45 parts) and the resulting mixture was stirred to obtain a black ink composition. Isopar M is an isoparaffinic mixture (produced by ExxonMobil Chemical).

### 2. Preparation of Yellow Ink Composition

Hinoact KF1-M (8 parts) was dissolved in diethylene glycol diethyl ether (50 parts). To the resulting solution, 20 parts of C. I. Pigment Yellow 97 and 2 parts of Solsperse 5000 (produced by Avecia KK) were added, and the resulting mixture was stirred and dispersed with an Eiger mill to obtain a yellow dispersion.

### 3. Preparation of Magenta Ink Composition

A magenta ink composition was prepared by the same method as that of the yellow ink composition except that C. I. Pigment Red 122 was used instead of C. I. Pigment Yellow 74.

### 4. Preparation of Cyan Ink Composition

A cyan ink composition was prepared by the same method as that of the yellow ink composition except that C. I. Pigment Blue 15:3 was used instead of C. I. Pigment Yellow 74.

### 5. Preparation of Ink Set

The black ink composition, the yellow ink composition, the magenta ink composition, and the cyan ink composition were combined into an ink set.

### III. Waste liquid Cleaning Treatment

Each of the waste ink absorbers prepared in Examples 1 to 4 in I above were mounted on an ink jet printer (PX-V630 (trade name) produced by Seiko Epson). An ink cartridge containing the ink set prepared in II above was also mounted. Waste liquid cleaning was repeated every 6 hours under an environment at 40° C. and 10% R.H., to determine the number of times of cleaning operations before the waste liquid tube was clogged due to the deposition of the waste liquid. The samples were rated according to the criteria below:

A: cleaning was conducted 31 times or more before clogging.

B: cleaning was conducted 21 to 30 times before clogging.

C: cleaning was conducted 10 to 20 times before clogging.

D: cleaning was conducted less than 10 times before clogging.

### IV. Results of Waste Liquid Cleaning Treatment

Rating of the waste ink absorber A: B

Rating of the waste ink absorber B: A

Rating of the waste ink absorber C: D

Rating of the waste ink absorber D: C

These results show that the waste ink absorber B could best withstand the repeated cleaning operation. In contrast, the ink absorbers C and D did not show sufficient absorbing property due to deterioration of the absorbers caused by waste ink and the solvent impregnated into the absorber. In particular, the waste ink absorber C had low absorbing property from the beginning of the test due to the oily solvent.

Thus, it was determined that the waste ink absorber of the invention has sufficient solvent resistance and waste ink absorbing property. Thus, the waste ink absorber can be effectively used in an ink jet recording device in which flushing, cleaning, or marginless printing is performed.

What is claimed is:

1. A waste ink absorber for an ink jet recording device wherein the ink is a non-aqueous ink, the waste ink absorber comprising:
a porous plastic prepared by sinter-molding plastic particles; and
an oily solvent which is impregnated into the porous plastic.

2. The waste ink absorber according to claim 1, wherein the plastic particles are polyolefin resin particles, vinyl resin particles, polyester resin particles, polyamide resin particles, polystyrene resin particles, acrylic resin particles, polysulfonic acid resin particles, polyether sulfonic acid resin particles, polyethylene sulfide resin particles, fluorocarbon resin particles, cross-linked polyolefin resin particles, or a combination thereof.

3. The waste ink absorber according to claim 1, wherein the oily solvent is an oily solvent having a melting point of 10° C. or less and a boiling point of 150° C. or more.

4. The waste ink absorber according to claim 3, wherein the oily solvent is a diethylene glycol compound.

5. The waste ink absorber according to claim 4, wherein the diethylene glycol compound is diethylene glycol diethyl ether.

6. The waste ink absorber according to claim 1, wherein the waste ink absorber is used in a waste ink tank including a waste ink diffusing-chamber and an absorber-retaining chamber, wherein the waste ink absorber is retained in the absorber-retaining chamber and not the waste ink diffusing-chamber.

7. The waste ink absorber according to claim 1, wherein the non-aqueous ink is a non-aqueous pigment ink.

8. The waste ink absorber according to claim 1, wherein the non-aqueous ink contains a saturated hydrocarbon solvent as a solvent.

9. The waste ink absorber according to claim 8, wherein the saturated hydrocarbon solvent is liquid paraffin.

10. An ink jet recording device comprising the waste ink absorber according to claim 1.

11. An ink jet recording device for recording non-aqueous ink, the ink jet comprising:
a waste ink tank including a waste ink diffusing-chamber and an absorber-retaining chamber; and
a waste ink absorber, comprising a porous plastic prepared by sinter-molding plastic particles and an oily solvent which is impregnated into the porous plastic;
wherein the waste ink absorber is retained in the absorber-retaining chamber and not the waste ink diffusing-chamber.

12. The ink jet recording device according to claim 11, wherein the plastic particles of the waste ink absorber are polyolefin resin particles, vinyl resin particles, polyester resin particles, polyamide resin particles, polystyrene resin particles, acrylic resin particles, polysulfonic acid resin particles, polyether sulfonic acid resin particles, polyethylene sulfide resin particles, fluorocarbon resin particles, cross-linked polyolefin resin particles, or a combination thereof.

13. The ink jet recording device according to claim 11, wherein the oily solvent of the waste ink absorber is an oily solvent having a melting point of 10° C. or less and a boiling point of 150° C. or more.

14. The ink jet recording device according to claim 13, wherein the oily solvent is a diethylene glycol compound.

15. The ink jet recording device according to claim 14, wherein the diethylene glycol compound is diethylene glycol diethyl ether.

16. The ink jet recording device according to claim 11, wherein the non-aqueous ink is a non-aqueous pigment ink.

17. The ink jet recording device according to claim 11, wherein the non-aqueous ink contains a saturated hydrocarbon solvent as a solvent.

18. The ink jet recording device according to claim 17, wherein the saturated hydrocarbon solvent is liquid paraffin.
